(19) United States
(12) Patent Application Publication
(10) Pub. No.: US 2013/0190937 A1
(43) Pub. Date: Jul. 25, 2013

(54) Systems, Methods, and Apparatus for Monitoring and Alerting Based on Energy Sources and Energy Consumption

(71) Applicant: Muhunthan Navaratnarajah, Marietta, GA (US)

(72) Inventor: Muhunthan Navaratnarajah, Marietta, GA (US)

(73) Assignee: GENERAL ELECTRIC COMPANY, Schenectady, NY (US)

(21) Appl. No.: 13/356,290

(22) Filed: Jan. 23, 2012

(51) Int. Cl. G05D 11/00

(52) U.S. Cl. 700/291

(57) ABSTRACT

Certain embodiments of the invention may include systems, methods, and apparatus for monitoring and alerting based on energy sources and energy consumption. According to an example embodiment of the invention, a method is provided for monitoring a customer's energy consumption from one or more energy sources, and for providing alerts to the customer. The method can include monitoring customer energy consumption from a utility grid; monitoring customer energy consumption from one or more alternative energy sources; determining when the customer energy consumption meets or exceeds a capability of the one or more alternative energy sources; generating an output, based at least on the determination, to indicate actual or forecasted customer energy consumption from the utility grid; and transmitting the output, wherein the output is accessible by the customer.

### FIELD OF THE INVENTION

This invention generally relates to smart meters, and in particular, to systems, methods, and apparatus for monitoring and alerting based on energy sources and energy consumption.

### BACKGROUND OF THE INVENTION

A smart grid is an electrical distribution network designed to accommodate suppliers and consumers, and to anticipate and efficiently respond to changing operating conditions. Smart meters can be utilized within a smart grid to enable services such as dynamic pricing, automated control of equipment, usage data, and scheduling and control of loads.

Customers who want to reduce their electrical costs or reliance on the grid can install local alternative power generation capabilities, such as solar panels, wind turbines, and batteries. Such alternative power generation and storage equipment may not be able to meet all of the consumer's power demands all the time, so connection to the electrical grid is usually required. However, coordination among the grid, the alternative power sources, and the load needs to be effectively managed, and a need may exist for modifying power consumption behavior based on available power from local alternative power generation equipment.

### BRIEF SUMMARY OF THE INVENTION

Some or all of the above needs may be addressed by certain embodiments of the invention. Certain embodiments of the invention may include systems, methods, and apparatus for monitoring and alerting based on energy sources and energy consumption.

According to an example embodiment of the invention, a method is provided for monitoring a customer's energy consumption from one or more energy sources, and for providing alerts to the customer. The method can include monitoring customer energy consumption from a utility grid; monitoring customer energy consumption from one or more alternative energy sources; determining when the customer energy consumption meets or exceeds a capability of the one or more alternative energy sources; generating an output, based at least on the determination, to indicate actual or forecasted customer energy consumption from the utility grid; and transmitting the output, wherein the output is accessible by the customer.

According to another example embodiment, a system is provided for monitoring and alerting based on energy sources and energy consumption. The system includes a communication interface and a smart meter. The smart meter includes at least one memory for storing data and computer-executable instructions; and at least one processor configured to access the at least one memory and further configured to execute the computer-executable instructions for: monitoring customer energy consumption from a utility grid; monitoring customer energy consumption from one or more alternative energy sources; determining when the customer energy consumption meets or exceeds a capability of the one or more alternative energy sources; generating an output, based at least on the determining, to indicate actual or forecasted customer energy consumption from the utility grid; and providing the output to the customer via the communication interface.

According to another example embodiment, an apparatus is provided for monitoring and alerting based on energy sources and energy consumption. The apparatus includes at least one memory for storing data and computer-executable instructions; and at least one processor configured to access the at least one memory and further configured to execute the computer-executable instructions for: monitoring customer energy consumption from a utility grid; monitoring customer energy consumption from one or more alternative energy sources; determining when the customer energy consumption meets or exceeds a capability of the one or more alternative energy sources; generating an output, based at least on the determining, to indicate actual or forecasted customer energy consumption from the utility grid; and providing the output to the customer via the communication interface.

Other embodiments and aspects of the invention are described in detail herein and are considered a part of the claimed inventions. Other embodiments and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of an illustrative active smart meter monitoring and messaging system, according to an example embodiment of the invention.

FIG. 2 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain embodiments of the invention may enable detection and coordination of power flow among the electrical grid, local alternative power sources, and loads. For example, the local alternative power sources may include solar panels, wind or other turbine generators, batteries, etc. that may provide some of the power needs of a customer. Example embodiments of the invention may provide messaging information that a customer may utilize in managing their use of certain power resources. For example, during times when the local alternative power sources are not producing enough electrical energy for a certain demand by the customer, power can be routed from the grid to meet the demand. Nevertheless, the customer can control their demand in many scenarios. For example, appliances can be operated during the daytime when solar power is available. Conversely, appliances can be turned off during times when power would need to be drawn from the gird.

According to an example embodiment of the invention, a smart meter may monitor and detect usage from the electrical grid and/or local alternative power sources, and may generate messages than can be made available to the customer. According to example embodiments, the messages may provide information that may be useful for the customer, and may be utilized for modifying usage patterns. In an example embodiment, messages may including an indication of which source is providing the power, pricing information, etc. According to and example embodiment, the messages may be provided to the customer through a wide variety of communication channels. For example, SMS messaging, e-mail, automated voice messaging, webpage, etc. According to other example embodiments, certain appliances or loads within the customer's premises may be controlled based on the messaging, and/or other pre-arranged agreements or schedules.

According to certain example embodiments, when the customer's own electricity generating source is generating and distributing all of the power to the customer, the smart meter may not read or register usage from the grid for billing by the utility. In an example embodiment, when the customer's own electricity generating source is not producing enough power to meet the demand required by the customer, the additional needed electricity may start flowing from utility via the grid, and the smart meter may monitor and read or register the grid power usage for billing. In another example embodiment, when the customer's own electricity generating source is not producing enough power to meet the demand, coordination to supply the additional needed electricity may include (a) drawing all needed power from the grid, or (b) blending and coordinating power from the grid and available power that is being locally generated. According to an example embodiment, the smart meter may be configured sell the excess energy to the utility when the customer's own generation source is generating energy that exceeds the demand of the customer. According to an example embodiment, when the excess energy is providing power to the grid, the smart meter may read or register the direction and amount of power flow.

According to example embodiments, messages may be generated and sent to the customer whenever there is a status change, for example, in power flow from or to the grid. According to example embodiments, the messaging may help the customer to be aware of their energy usage and cost, and may provide information for taking necessary actions to reduce usage, or to knowingly use the grid power at a communicated, predetermined, or scheduled price. According to an example embodiment, the messaging may alert the customer when they are making money from their generation capacity and usage. According to example embodiments, the messages may be generated and sent according to certain pre-determined thresholds.

Various hardware components and computer readable modules for monitoring and alerting based on energy sources and energy consumption or production, according to example embodiments of the invention, will now be described with reference to the accompanying figures.

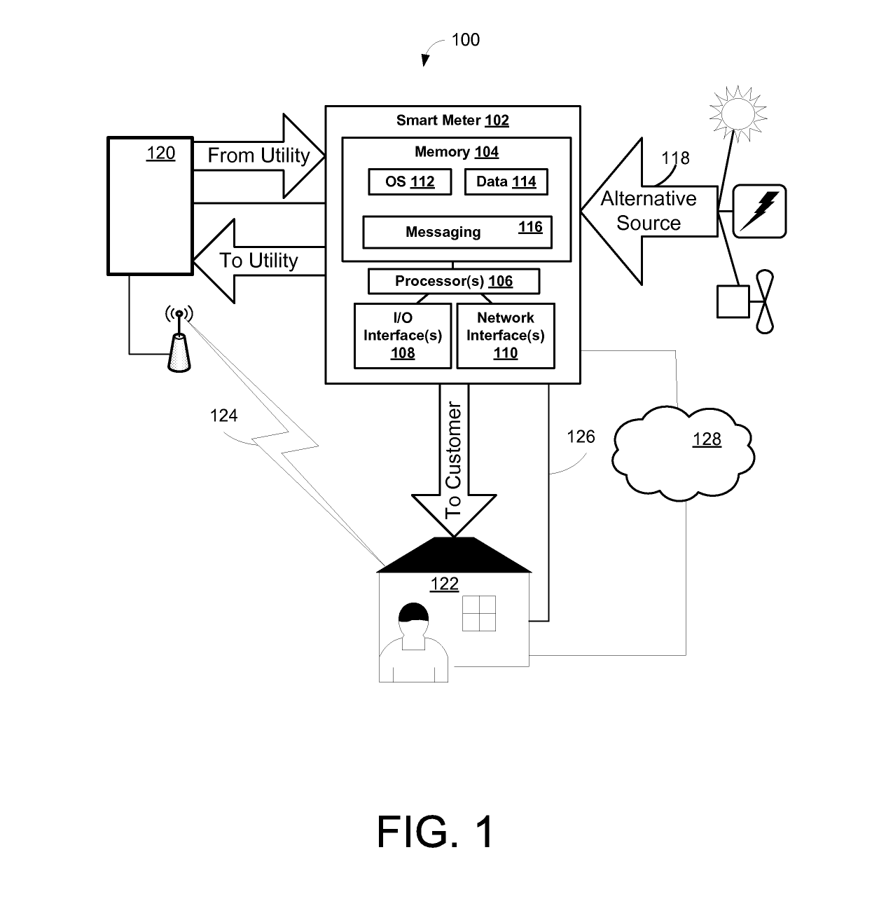

FIG. 1 illustrates an example block diagram of an illustrative active smart meter monitoring and messaging system 100, according to an example embodiment of the invention. According to example embodiments of the invention, the system 100 includes a smart meter 102 that may include a memory 104, one or more processors 106 in communication with the memory 104, and one or more input/output interfaces 108 in communication with the one or more processors 106. In an example embodiment, the system may include one or more network interfaces 110 in communication with the one or more processors 106. According to an example embodiment, the memory 104 may include one or more operating systems 112 and data 114. In an example embodiment, the memory 104 may include a messaging module 116. In an example embodiment, the messaging module 116 may generate and provide messages based on the status or change of status of electrical power being consumed from a utility 120, or excess power being supplied to the utility 120 from an alternative source 118. In an example embodiment, the messaging module 116 may generate and provide messages based on usage by the customer 122 from either the utility 120, the alternative source 118, or both.

According to an example embodiment, the smart meter 102 may deliver messages to the customer 122 via wired communications 126, through one or more networks 128, or via wireless communication 126 (such as SMS, cell, etc.).

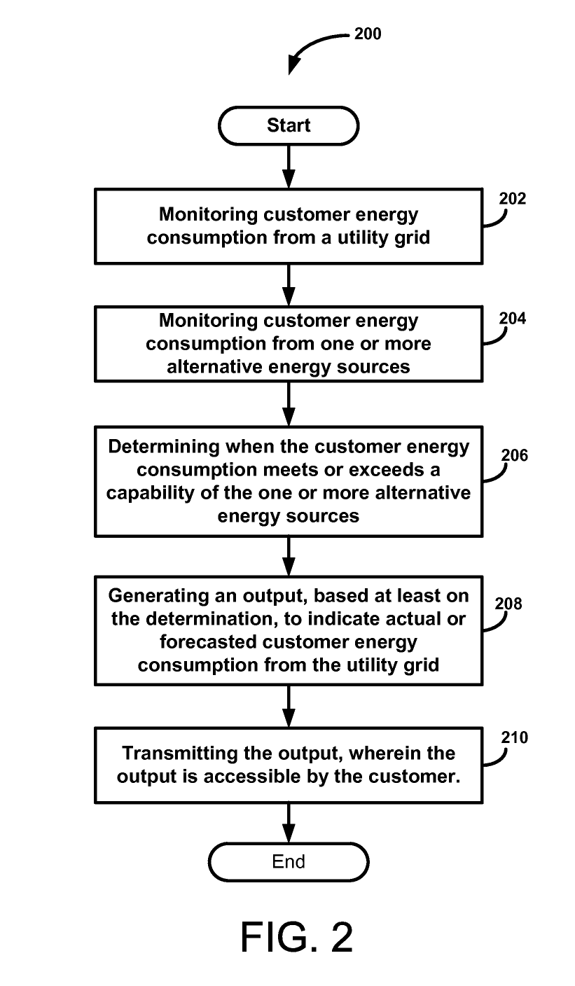

An example method 200 for monitoring and alerting based on energy sources and energy consumption or production will now be described with reference to the flowchart of FIG. 2. The method 200 starts in block 202 and according to an example embodiment of the invention, includes monitoring customer energy consumption from a utility grid. In block 204, the method 200 includes monitoring customer energy consumption from one or more alternative energy sources. In block 206, the method 200 includes determining when the customer energy consumption meets or exceeds a capability of the one or more alternative energy sources. In block 208, the method 200 includes generating an output, based at least on the determination, to indicate actual or forecasted customer energy consumption from the utility grid. In block 210, the method 200 includes transmitting the output, wherein the output is accessible by the customer. The method 200 ends after block 210.

According to an example embodiment, monitoring the one or more alternative energy sources includes monitoring a power source that generates and distributes energy to the customer independent of energy supplied from the utility grid. According to an example embodiment, generating the output is further based on a monitored direction of energy flow from or to the utility grid. An example embodiment includes determining when the customer energy consumption is less than a capability of the one or more alternative energy sources. An example embodiment includes generating an output, based at least on the determination, to indicate that alternative energy is being supplied to the utility grid. According to an example embodiment, generating or transmitting the output is based at least in part on one or more pre-defined parameters. According to an example embodiment, one or more pre-defined parameters include one or more of energy costs to the customer, energy purchase price from the utility, frequency of customer energy consumption from the utility grid, customer-defined limits, or customer-defined scheduling.

According to additional example embodiments, a system or apparatus is provided for monitoring and alerting based on energy sources and energy consumption. The system includes a communication interface and a smart meter. The smart meter or apparatus includes at least one memory for storing data and computer-executable instructions; and at least one processor configured to access the at least one memory and further configured to execute the computer-executable instructions for: monitoring customer energy consumption from a utility grid; monitoring customer energy consumption from one or more alternative energy sources; determining when the customer energy consumption meets or exceeds a capability of the one or more alternative energy sources; generating an output, based at least on the determining, to indicate actual or forecasted customer energy consumption from the utility grid; and providing the output to the customer via the communication interface.

According to an example embodiment, monitoring the one or more alternative energy sources includes monitoring a power source that generates and distributes energy to the customer independent of energy supplied from the utility grid. According to an example embodiment, the at least one processor is further configured for generating the output based on a monitored direction of energy flow from or to the utility grid. According to an example embodiment, the at least one processor is further configured for determining when the customer energy consumption is less than a capability of the one or more alternative energy sources. According to an example embodiment, the at least one processor is further configured for generating an output, based at least on the determining, to indicate that alternative energy is being supplied to the utility grid. According to an example embodiment, generating or providing the output is based at least in part on one or more pre-defined parameters, wherein the one or more pre-defined parameters include one or more of energy costs to the customer, energy purchase price from the utility, frequency of customer energy consumption from the utility grid, customer-defined limits, or customer-defined scheduling.

According to example embodiments, certain technical effects can be provided, such as creating certain systems, methods, and apparatus that monitor a customer's energy consumption from one or more energy sources or the production of excess energy. Example embodiments of the invention can provide the further technical effects of providing systems, methods, and apparatus for providing alerts to the customer based on the consumption from one or more energy sources or the production of excess energy.

In example embodiments of the invention, the active smart meter monitoring and messaging system 100 may include any number of hardware and/or software applications that are executed to facilitate any of the operations.

In example embodiments, one or more I/O interfaces may facilitate communication between the active smart meter monitoring and messaging system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the active smart meter monitoring and messaging system 100. The one or more I/O interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the active smart meter monitoring and messaging system 100 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the invention may include the active smart meter monitoring and messaging system 100 with more or less of the components illustrated in FIG. 1.

Certain embodiments of the invention are described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising executing computer executable instructions by one or more processors for:
monitoring customer energy consumption from a utility grid;
monitoring customer energy consumption from one or more alternative energy sources;
determining when the customer energy consumption meets or exceeds a capability of the one or more alternative energy sources;
generating an output, based at least on the determination, to indicate actual or forecasted customer energy consumption from the utility grid; and
transmitting the output, wherein the output is accessible by the customer.

2. The method of claim 1 wherein monitoring the one or more alternative energy sources comprises monitoring a power source that generates and distributes energy to the customer independent of energy supplied from the utility grid.

3. The method of claim 1, wherein generating the output is further based on a monitored direction of energy flow from or to the utility grid.

4. The method of claim 1, further comprising determining when the customer energy consumption is less than a capability of the one or more alternative energy sources.

5. The method of claim 4, further comprising generating an output, based at least on the determination, to indicate that alternative energy is being supplied to the utility grid.

6. The method of claim 1, wherein generating or transmitting the output is based at least in part on one or more pre-defined parameters.

7. The method of claim 6, wherein the one or more pre-defined parameters comprise one or more of energy costs to the customer, energy purchase price from the utility, frequency of customer energy consumption from the utility grid, customer-defined limits, or customer-defined scheduling.

8. A system comprising:
a communication interface;
a smart meter comprising:
at least one memory for storing data and computer-executable instructions; and
at least one processor configured to access the at least one memory and further configured to execute the computer-executable instructions for:
monitoring customer energy consumption from a utility grid;
monitoring customer energy consumption from one or more alternative energy sources;
determining when the customer energy consumption meets or exceeds a capability of the one or more alternative energy sources;
generating an output, based at least on the determining, to indicate actual or forecasted customer energy consumption from the utility grid; and
providing the output to the customer via the communication interface.

9. The system of claim 8, wherein monitoring the one or more alternative energy sources comprises monitoring a power source that generates and distributes energy to the customer independent of energy supplied from the utility grid.

10. The system of claim 8, wherein the at least one processor is further configured for generating the output based on a monitored direction of energy flow from or to the utility grid.

11. The system of claim 8, wherein the at least one processor is further configured for determining when the customer energy consumption is less than a capability of the one or more alternative energy sources.

12. The system of claim 11, wherein the at least one processor is further configured for generating an output, based at least on the determining, to indicate that alternative energy is being supplied to the utility grid.

13. The system of claim 8, wherein generating or providing the output is based at least in part on one or more pre-defined parameters.

14. The system of claim 13, wherein the one or more pre-defined parameters comprise one or more of energy costs to the customer, energy purchase price from the utility, frequency of customer energy consumption from the utility grid, customer-defined limits, or customer-defined scheduling.

15. An apparatus comprising:
at least one memory for storing data and computer-executable instructions; and
at least one processor configured to access the at least one memory and further configured to execute the computer-executable instructions for:
monitoring customer energy consumption from a utility grid;
monitoring customer energy consumption from one or more alternative energy sources;
determining when the customer energy consumption meets or exceeds a capability of the one or more alternative energy sources;
generating an output, based at least on the determining, to indicate actual or forecasted customer energy consumption from the utility grid; and
providing the output to the customer.

16. The apparatus of claim 15, wherein the at least one processor is further configured for generating the output based on a monitored direction of energy flow from or to the utility grid.

17. The apparatus of claim 15, wherein the at least one processor is further configured for determining when the customer energy consumption is less than a capability of the one or more alternative energy sources.

18. The apparatus of claim 17, wherein the at least one processor is further configured for generating an output, based at least on the determining, to indicate that alternative energy is being supplied to the utility grid.

19. The apparatus of claim 15, wherein generating or providing the output is based at least in part on one or more pre-defined parameters.

20. The apparatus of claim 15, wherein the one or more pre-defined parameters comprise one or more of energy costs to the customer, energy purchase price from the utility, frequency of customer energy consumption from the utility grid, customer-defined limits, or customer-defined scheduling.
